(19) United States
(12) Patent Application Publication
(10) Pub. No.: US 2025/0137261 A1
(43) Pub. Date: May 1, 2025

(54) MOTORIZED NON-VERTICAL SUN PROTECTION SCREEN COMPRISING THE CABLE ANCHORING AND A MOUNTING METHOD

(71) Applicant: RENSON NV, Waregem (BE)

(72) Inventors: John Urbain HOUFFLYN, Waregem (BE); Sofie RUMBAUT, Gent (BE); John Peter MEINSTER, Gentbrugge (BE)

(21) Appl. No.: 18/835,178

(22) PCT Filed: Apr. 28, 2023
(86) PCT No.: PCT/IB2023/054423

§ 371 Date: Aug. 1, 2024

(30) Foreign Application Priority Data
May 2, 2022 (BE) 2022/5328

(51) Int. Cl. E04F 10/06

(52) U.S. Cl. CPC E04F 10/0655; E04F 10/0607

(57) ABSTRACT

A cable anchoring for a motorized non-vertical sun protection screen. The cable anchoring comprises: a frame having an entry opening for receiving a cable end; a bobbin for winding the cable end thereon; a worm gear fixedly attached to the bobbin; and a worm attached on the frame and engaging the worm gear, wherein the worm and worm gear together forming a self-locking worm gear reducer. A self-locking worm gear reducer can only rotate minimally under load. By winding the cable end onto a bobbin, which itself is fixedly attached to the worm gear, the cable end is firmly connected to the self-locking worm gear reducer. A dynamic load (e.g. during winding or unwinding) on the tension cable has no effect on the bobbin due to the self-locking worm gear reducer. Therefor, the cable anchoring according to the present invention has no or only minimal wear on the tension cable.

### CROSS-REFERENCE TO RELATED APPLICATION(S)

This present application is a national stage application of International Patent Application No. PCT/IB2023/054423, filed Apr. 28, 2023, which claims priority to Belgium Patent Application No. BE2022/5328, filed May 2, 2022, the disclosures of which are hereby incorporated by reference in their entireties.

### TECHNICAL FIELD

The present disclosure relates to a motorized non-vertical sun protection screen comprising a cable anchoring. The present disclosure furthermore relates to a method for mounting a cable anchoring in a motorized non-vertical sun protection screen and to a method for replacing such an existing cable anchoring in a motorized non-vertical sun protection screen.

### BACKGROUND

Motorized non-vertical sun protection screens are usually set up to shield a specific location from sunlight. For example, such sun protection screens are often set up at homes, restaurants, shops, etc. to shield a window, skylight, veranda, terrace, or the like from sun rays. Such sun protection screens comprise a fabric (also referred to by the term “screen”) that is provided at its bottom side with a bottom slat. With a vertically arranged sun protection screen, an additional weight of the bottom slat (typically at least 10 kg per 3 meter screen width) causes a tension on the screen as a result of gravity. With “vertically arranged” is meant that the sun protection screen is located in a vertical plane and slides in that plane, wherein the bottom slat is located on the side of the sun protection screen facing an earth's surface.

However, with non-vertical sun protection screens, screen tensioning through gravity is not possible and a separate tensioning system is used. With “non-vertically arranged” is meant that the sun protection screen is in one of the following situations: the sun protection screen is located in a non-vertical plane and slides in that plane; the sun protection screen is located in a vertical plane and slides in a horizontal direction in this plane (e.g. the Slidefix® commercialised by the current applicant); or; the sun protection screen is located in a vertical plane and slides in this plane with the bottom slat on the side of the sun protection screen facing away from the earth's surface. If a screen cannot be wound and unwound in an essentially vertical plane, such a tensioning system also allows the bottom slat to be pushed out. Such a tensioning system helps to prevent a screen from excessive movement or flapping or damage by wind. In addition, such a tensioning system prevents a screen, which is mounted, for example, on a slope towards a window or which is fitted as the roof of a terrace canopy without glazing, from sinking under its own weight and touching the window or entering the terrace canopy.

A schematic example of a known tensioning system in a motorized non-vertical sun protection screen is shown in FIG. 1. The sun protection screen comprises a bottom slat 1 connected to a screen (not shown), which bottom slat 1 is guided on both sides in a side guide 2. The tensioning system comprises a tension cable 3 (also referred to as “tension strip”). One end of the tensioning cable 3 of such a tensioning system runs on a wheel (also referred to by the term “bobbin”) which is mounted at the end of the screen roller. When the screen is rolled up, the tension cable 3 rolls on this wheel. When the screen is rolled down, the tension cable 3 is unwound. The tension cable 3 is then guided via guide wheels 4 (also referred to as “pulley”) to near one end of the bottom slat 1 where a cable anchoring 5 is provided in which the other end of the tension cable 3 is anchored by clamping this end in the cable anchoring 5. The tensioning cable 3 is further kept under tension by means of, for example, a spring system 6. In this way, such a tensioning system keeps the screen tensioned in both the winding and unwinding direction.

At present, a specific type of tension rope is used, namely a rope comprising a core of pre-stretched parallel Dyneema® strands surrounded by a woven sheath. Such a cable is flexible enough to allow the sharp bends of the pulleys and also strong enough not to stretch under prolonged load.

A problem with the current tensioning system is the cable anchoring in the bottom slat. This is because, during winding and unwinding, there is a dynamic load of the tension cable 3, partly as a result of the spring system 6. This dynamic load causes small, but frequent, reciprocal shifts of the cable end that is clamped in the cable anchoring 5. This causes wear of the woven sheath. Over time, the woven sheath locally unravels at the cable anchoring, as a result of which the tension cable 3 breaks and the tensioning system is no longer operational.

### SUMMARY

In one embodiment, a motorized non-vertical sun protection screen comprises: a frame provided with a housing, a first side guide and a second side guide; a screen roller which is rotatably attached in the housing; a screen which is fixedly attached to the screen roller at one end, wherein the screen can be wound and unwound from the screen roller; a bottom slat fixedly attached to a second end of the screen, which second end is located opposite to said first end, wherein the bottom slat has a first end and a second end, each guided in one of said side guides; and a tensioning system for keeping the screen under tension, which tensioning system comprises: a first cable extending between a first end and a second end; a first bobbin positioned in the housing and to which the first end of the first cable is attached, wherein the first cable can be wound and unwound from the first bobbin; a first cable anchoring fixedly attached within the bottom slat and with which the second end of the first cable is anchored; a second cable extending between a first end and a second end; a second bobbin positioned in the housing opposite the first bobbin and having the first end of the second cable attached thereto, wherein the second cable can be wound and unwound from the second bobbin; and a second cable anchoring fixedly attached within the bottom slat and with which the second end of the second cable is anchored, each cable anchoring comprising: a frame placed in the bottom slat of the motorized non-vertical sun protection screen, said frame having an entry opening configured for receiving a cable end of a respective one of said cables; a bobbin rotatably attached on the frame of the cable anchoring and configured for winding said cable end thereon; a worm gear fixedly attached to the bobbin; and a worm attached on the frame and engaging the worm gear, wherein the worm and worm gear together form a self-locking worm gear reducer.

A self-locking worm gear reducer cannot (or only minimally) rotate under a load. Whether a worm gear reducer is self-locking or not depends, a.o., on the angle of inclination of a screw thread, the coefficient of friction of the gearing and the friction angle. The skilled person is assumed to be familiar with a worm gear reducer and whether or not it is self-locking. By winding the cable end onto a bobbin, which itself is fixedly attached to the worm gear, the cable end is fixedly connected to the self-locking worm gear reducer. A dynamic load (e.g. during winding or unwinding) on the cable, has no effect on the bobbin due to the self-locking worm gear reducer. In other words, the bobbin does not undergo any rotation due to the dynamic load and therefore no wear of the tension cable is possible. In addition, even a small rotation of the bobbin, e.g. due to a minimal rotation of the worm gear reducer, will only result in a partial winding or unwinding of the cable on the bobbin. Such a movement also has no or only minimal wear on the tension cable. The cable anchoring therefore has no or only minimal wear on the tension cable, which is an improvement over the current cable anchoring based on clamping a cable part.

In an embodiment, the worm has a thread with an angle of inclination of at most 3°, preferably at most 2°, and more preferably at most 1°. Such an angle of inclination results in a statically and dynamically self-locking worm gear reducer, such that there is no rotation of the bobbin during winding and unwinding of the screen. Furthermore, an angle of inclination of at most 1° is advantageous because the worm gear reducer is then completely self-locking, even in the presence of vibrations.

In an embodiment, the worm gear has a pitch circle diameter of at most 25 mm, in particular at most 20 mm, more in particular at most 17 mm, and most in particular at most 13 mm. This allows the cable anchoring to be placed in the standard dimensions of a bottom slat.

In an embodiment, the worm gear has an outer diameter of at most 35 mm, in particular at most 30 mm, more in particular at most 25 mm, and most in particular at most 22 mm. This allows the cable anchoring to be placed in the standard dimensions of a bottom slat.

In an embodiment, the worm has a screw thread with an outer diameter of at most 25 mm, in particular at most 20 mm, more in particular at most 17 mm, and most in particular at most 14 mm. This allows the cable anchoring to be placed in the standard dimensions of a bottom slat.

In an embodiment, the tensioning system further comprises: a first guide for guiding the first cable from the housing to the bottom slat through the first side guide via the first end of the bottom slat; and a second guide for guiding the second cable from the housing to the bottom slat through the second side guide via the second end of the bottom slat. Each guide includes: a first pulley within the respective side guide near an end thereof, which end is located opposite to the housing; a second pulley within the bottom slat near a respective end thereof; and a third pulley within the bottom slat. The tensioning system further comprises one or more tensioning elements which pull the third pulley of the first guide away from the first end of the bottom slat and which pulls the third pulley of the second guide away from the second end of the bottom slat. In particular, said one or more tensioning elements are formed by a spring element, in particular a tension spring, which interconnects the third pulley of the first guide and the third pulley of the second guide. Preferably, the first cable anchoring is located between the second pulley and the third pulley of the first guide and the second cable anchoring is located between the second pulley and the third pulley of the second guide.

Such guides allow to completely hide the tension cables from view. The use of three pulleys in the described positions allows to set any position between the side guides as the end position for the screen in its open state. In addition, the tension on the cables causes the first and second pulleys to pull together such that the bottom slat is pulled away from the housing. The use of spring elements to interconnect the third pulleys is also an efficient way to keep both tension cables under the same tension. Placing the cable anchorings between the second and third pulleys of their respective guides is further advantageous because the cable ends are then located on a different side of the third pulley than the tension elements which are typically centrally located in the bottom slat.

In an embodiment, each cable comprises a core surrounded by a woven sheath. The core is may be formed by a plurality of parallel strands which are pre-stretched. The strands may be manufactured from a synthetic fibre, in particular a synthetic fibre based on polyethylene, more in particular ultra-high molecular weight polyethylene. Such cables are known per se and appear to be extremely suitable for the current application in view of their flexibility on the one hand, which allows them to be placed through the side guides and bottom slat, and their strength, such that they do not stretch under long-term static and frequent dynamic loads.

A method for mounting a cable anchoring as described above in a motorized non-vertical sun protection screen comprises: securing the frame of the cable anchoring in a bottom slat of the motorized non-vertical sun protection screen; inserting a cable end of a cable through the entry opening and attaching it to the bobbin; and turning the worm for tensioning the cable.

The method results in a motorized non-vertical sun protection screen provided with the cable anchorings described above and therefore achieves the same advantages, in particular the low or non-existent wear of the (tension) cables in the cable anchoring. In addition, it is possible to have this method carried out by one person, which is not possible with the existing systems. The latter requires always a second person to support the heavy bottom slat, in particular near the desired end position, while the first person puts the system under tension. The current cable anchoring allows the bottom slat to be supported at the bottom of the guides and, by turning the worm, both to determine the desired end position of the bottom slat and to tension the tensioning system.

In an embodiment, the method comprises in advance: relaxing a cable in the motorized non-vertical sun protection screen; detaching a cable end of the cable from an existing cable anchoring; and removing the existing cable anchoring from a bottom slat of the motorized non-vertical sun protection screen. This allows to replace an existing cable anchoring in a motorized non-vertical sun protection screen with a cable anchoring as described above.

### BRIEF DESCRIPTION OF THE DRAWINGS

Various embodiments will hereinafter be explained in further detail with reference to the following description and the accompanying drawings.

FIG. 1 shows a schematic representation of a known tensioning system in a motorized non-vertical sun protection screen.

FIG. 2 shows a schematic representation of a motorized non-vertical sun protection screen.

FIG. 3 shows a schematic representation of a tensioning system.

FIG. 4 shows a perspective view of a cable anchoring.

FIG. 5 shows an exploded view of the cable anchoring of FIG. 4.

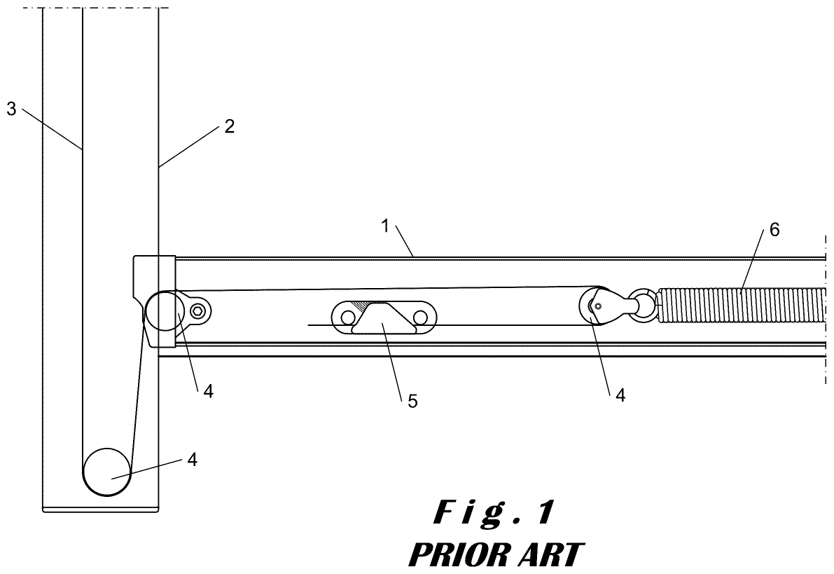

### DETAILED DESCRIPTION

Various embodiments will be described below with reference to specific embodiments and with reference to specific drawings, but the disclosure is not limited thereto and is only defined by the claims. The drawings shown here are only schematic representations and are not limitative. In the drawings, the dimensions of certain parts may be enlarged, which means that the parts in question are not shown to scale, and this only for illustrative purposes. The dimensions and relative dimensions do not necessarily correspond to the actual practical embodiments disclosed herein.

In addition, terms such as “first”, “second”, “third”, and the like are used in the description and in the claims to distinguish between similar elements and not necessarily to indicate a sequential or chronological order. The terms in question are interchangeable in appropriate circumstances, and the embodiments may operate in different orders than those described or illustrated herein.

In addition, terms such as “top”, “bottom”, “above”, “under”, “left”, “right”, and the like are used in the description and in the claims for descriptive purposes. The terms thus used are interchangeable in appropriate circumstances, and the various embodiments may operate in orientations other than those described or illustrated herein.

The term “comprising” and derivative terms, as used in the claims, should not be construed as being limited to the means set forth in each case thereafter; the term does not exclude other elements or steps. The term should be interpreted a specification of the listed properties, integers, steps, or components referred to, without, however, excluding the presence or addition of one or more additional properties, integers, steps, or components, or groups thereof. The scope of an expression such as “a device comprising means A and B” is therefore not limited only to devices consisting purely of components A and B. Rather, what is meant is that the only relevant components are A and B.

The term “substantially” may comprise variations of +/−10% or less, preferably +/−5% or less, more preferably +/−1% or less, and more preferably +/−0.1% or less, of the specified state, insofar as the variations are appropriate to function. It is to be understood that the term “substantially A” is intended to include “A”.

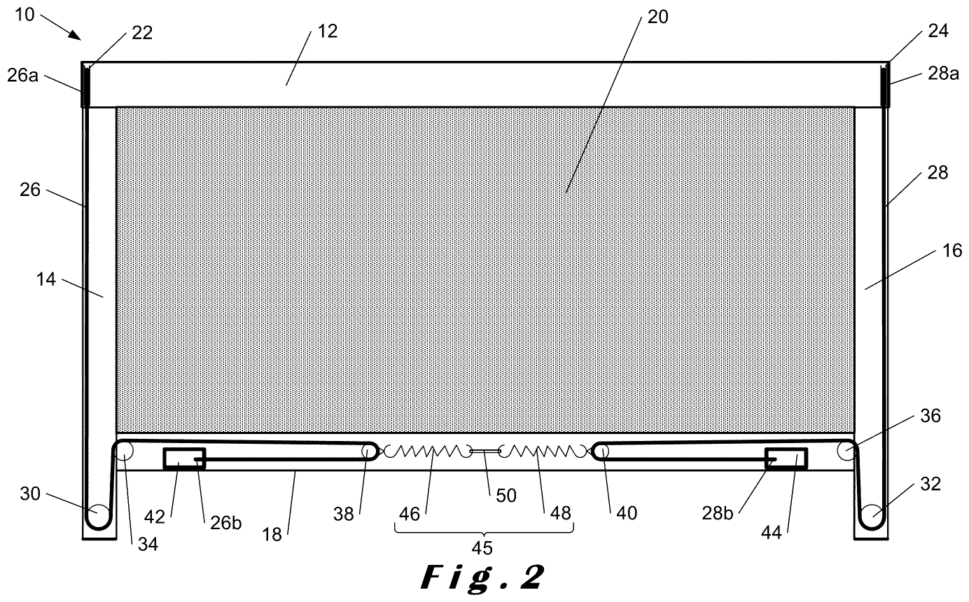

FIG. 2 illustrates one embodiment of a motorized non-vertical sun protection screen 10. The sun protection screen 10 comprises a frame formed by a housing 12, a left side guide 14 and a right side guide 16. The side guides 14, 16 serve, a.o., to guide a bottom slat 18. These elements (i.e. the housing 12, the side guides 14, 16 and the bottom slat 18) are typically made of a rigid material. This can be aluminium, for example. Aluminium has many advantages as a material, as it is at the same time robust and light, resistant to bad weather conditions and requires little maintenance. However, other materials are also suitable and their advantages or disadvantages are assumed to be known to the skilled person. These different elements can be produced using different techniques depending on the material, including extrusion, milling, setting, casting, welding, and so on. The appropriate manufacturing technique is presumed to be known by the skilled person. These elements may be manufactured by means of an extrusion process. These elements are typically hollow manufactured and allow various other components to be placed therein and thus hide them from view. The frame is typically placed on an existing structure, for example on the outside of a window or as the roof infill of a terrace canopy. The various elements of the frame may comprise several components and should not be integrally manufactured. Hence, although FIG. 2 shows that the housing extends to above the side guides, it is also possible for the side guides to extend to the top of the frame with the housing in between, wherein the bobbins 26a, 28a are located within the housing which is conceptually formed to include the top portions of each side guide.

The motorized non-vertical sun protection screen 10 further comprises a screen or fabric 20 which extends between the side guides 14, 16. The left and right sides of the screen 20 may also be guided in a corresponding side guide 14, 16 and tensioned there between, for example by a zipper system. The screen 20 is attached for winding and unwinding on a screen roller (not shown) located within the housing 12. The bottom slat 18 is attached to the end of the screen 20 opposite the screen roller. A motor (not shown) is also provided for driving the screen roller. In the wound state of the screen 20, it is located substantially entirely in the housing. FIG. 2 illustrates the (partially) unwound state of the screen 20. The screen 6a mainly serves as a sun protection screen. The screen 20 can be made from different materials, such as based on plastic, for instance polyester or polymethyl methacrylate (PMMA) or glass fibre and can be manufactured by means of different techniques. The skilled person is assumed to be familiar with the possible materials and manufacturing methods of screens.

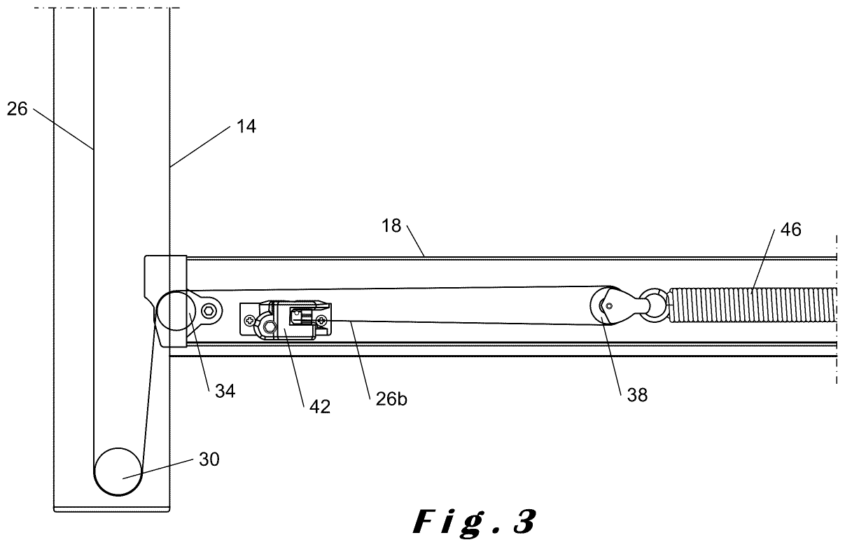

A tensioning system is provided for keeping the screen 20 under tension. In the embodiment shown, this tensioning system comprises a left cable 26 and a right cable 28. The cables 26, 28 extend between a first end 26a, 28a in the housing 12 and a second end 26b, 28b in the bottom slat 18. Various elements are provided for guiding the cables. Specifically, a wheel (or bobbin) 22, 24 is provided at opposite ends of the housing 12 on which the first end 26a, 28a is wound. Typically, these wheels 22, 24 are fixedly attached on the screen roller and thus also driven by the motor. In each screen guide 14, 16 a first pulley 30, 32 is provided, in particular at the end of the screen guides 14, 16 that is located opposite to the housing 12. Furthermore, two pulleys 34, 36 are provided at opposite ends of the bottom slat 18 which guide the cable 26, 28 from the screen guide 14, 16 to the bottom slat 18. In the bottom slat 18, in particular in a middle portion thereof, there are two further pulleys 38, 40 over which the cable 26, 28 runs. In this way, each cable 26, 28 extends from their wheel 22, 24 through the screen guide 14, 16 over the first pulley 30, 32 into the bottom slat 18 via the second pulley 34, 36 and to terminate via the third pulley 38, 40 at an anchoring 42, 44. The cable anchoring 42, 44 is further described in greater detail with reference to FIGS. 3 to 5.

The tensioning system further comprises a tensioning element 45 which holds each cable 26, 28 under a desired tension. By keeping the cables 26, 28 under tension, the bottom slat 18 is pushed away from the housing 12. This is in particular due to the placement of the various pulleys 30, 32, 34, 36, which are caused, by the tension on the cables 26, 28, to undergo a force directed towards each other. In this way, the screen 20 is always tightly tensioned. In general, the tension element 45 should cause pulley 38 to undergo a force directed away from pulley 34 and the same for pulley 40 which is subjected to a force directed away from pulley 36. This can be achieved in a simple manner by adjusting the pulleys 38, 40 by means of one or more tension springs. In the embodiment shown, use is made of two tension springs 46, 48, which are interconnected via connection 50. In this way, both cables 26, 28 are also subject to the same tension. It should be clear that use can also be made of one tension spring which directly interconnects both pulleys 38, 40. The use of a tension spring, the number of spring elements, their strength, etc. are dependent on the desired tension on the cables and is assumed to be known by the skilled person.

Although there are various possibilities with regard to the type of cables 26, 28, it should be taken into account that the cables 26, 28 are intended to be continuously under tension. In other words, the cables 26, 28 are may be pre-stretched to avoid subsequent stretching. In addition, the cables 26, 28 should be flexible enough to make the sharp 180° bends over the various pulleys. In the embodiment shown, cables 26, 28 are used which have a core surrounded by a woven sheath. The core provides the necessary properties of the cables 26, 28 and the woven sheath serves to hold the core together. The core typically comprises parallel strands that have been pre-stretched. The strands can be manufactured from a synthetic fibre, in particular a synthetic fibre based on polyethylene, more in particular ultra-high molecular weight polyethylene, such as Dyneema®.

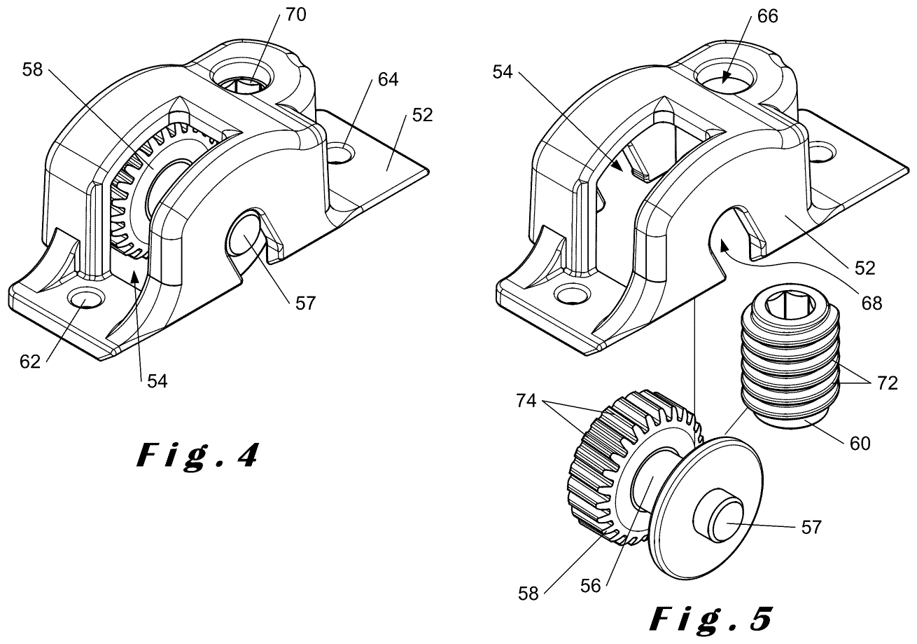

The cable anchoring 42, 44 will be described with reference to FIGS. 3 to 5. FIGS. 4 and 5 show the cable anchoring 42, 44 by themselves, while FIG. 3 shows the mounted state in a bottom slat 18.

The cable anchoring 42, 44 comprises a frame 52 that is fixedly attached in the bottom slat 18. In the embodiment shown, this is achieved by bolts or screws that are placed through openings 62, 64 provided for this purpose and that are fixedly attached in the bottom slat 18. The frame 52 further comprises an entry opening 54 through which the cable end 26b, 28b is placed. The cable anchoring 42, 44 further comprises a bobbin 56 onto which the cable end 26b, 28b is fixedly attached and wound. The cable anchoring 42, 44 further comprises a self-locking worm gear reducer comprising a worm gear 58 and a worm 60. The bobbin 56 and the worm gear 58 are fixedly attached to each other and are integrally manufactured in the embodiment shown. The bobbin 56 and the worm gear 58 are attached on the same shaft 57 which is rotatably attached on the frame 52. In particular, the ends of the shaft 57 sit in recesses 68 in the frame 52 provided for this purpose. Of course, the bobbin 56 and the worm gear 58 need not be integrally manufactured or they may be placed on different shafts. Furthermore, one or more elements can also be provided between the bobbin 56 and the worm gear 58. It is crucial that the bobbin 56 and the worm gear 58 cannot rotate separately from each other. The worm gear 58 has a toothing 74 that engages a screw thread 72 provided on the worm 60. Due to the use of a self-locking worm gear reducer, there is no (or only minimal) rotation of the bobbin 56 during winding and unwinding of the screen 20, which action typically applies a dynamic load to the cables 26, 28. Since the cable end 26b, 28b is wound on the bobbin 56, there is (hardly) any wear due to the dynamic load.

In the embodiment shown, the worm gear reducer is self-locking due by making the angle of inclination of the screw thread 72 (i.e. the angle made by the screw thread and relative to a plane perpendicular to the longitudinal direction of the worm 60; this angle is equal to the complement of the helix angle) sufficiently small. For example, it is less than 3° such that there is both static and dynamic self-locking and this angle may be smaller than 1° such that there is static and dynamic self-locking even in the presence of vibration. The skilled person is familiar with other ways of making a worm gear reducer self-locking, for example by making the angle of friction of the worm gear reducer sufficiently small.

In the embodiment shown, the outer diameter of the toothing 74 is between 21 and 22 mm, the outer diameter of the screw thread 72 is between 13 and 14 mm, and the pitch circle diameter of the screw thread 72 is between 12 and 13 mm. However, as described above, other dimensions are possible as long as they allow the cable anchoring 42, 44 (whose dimension is mainly determined by the worm gear reducer) to be placed in (the standard sizes of) a bottom slat 18.

To place a cable anchoring 42, 44 in the bottom slat 18 of a motorized non-vertical sun protection screen 10, it is possible to proceed as follows. The screen 20 is completely unwound to near the desired end position of the bottom slat 18 in the side guides 14, 16. This is typically the bottom side of the side guides 14, 16, but this is not necessarily the case, and the position shown in FIG. 2 can also be an end position. Subsequently, the cable anchorings 42, 44 are placed and fixedly attached in the bottom slat 18. Alternatively, this could also have been done in advance. Subsequently, the cable ends 26b, 28b are inserted into the cable anchorings 42, 44 and fixedly attached to the bobbin 56. At this stage, the cables 26, 28 may be completely unwound from the wheels 22, 24 and excess material can be cut off near the cable ends 26b, 28b. The system is then tensioned by means of the self-locking worm gear reducer. In particular, the cables 26, 28 can be wound on or unwound from the bobbin 56 to increase or decrease the cable tension. To this end, the worm 60 is provided on its inside with gripping means 70 for tools, for instance a hexagonal opening that can be operated by an Allen key. Correspondingly, an opening 68 is provided in the frame 52 which gives access to the gripping means 70. A rotation of the worm 60 namely leads to a rotation of the bobbin 56.

While certain aspects of the disclosure have been described with respect to specific embodiments, it is to be understood that these aspects may be implemented in other forms within the scope of protection as defined by the claims.

1. A motorized non-vertical sun protection screen comprising:
a frame provided with a housing, a first side guide and a second side guide;
a screen roller rotatably attached in the housing;
a screen fixedly attached at a first end to the screen roller, wherein the screen can be wound and unwound from the screen roller;
a bottom slat fixedly attached to a second end of the screen, the second end being located opposite to the first end, wherein the bottom slat has a first end and a second end, each guided in one of the first and second side guides; and
a tensioning system for keeping the screen under tension, which tensioning system comprises:
a first cable extending between a first end and a second end;
a first bobbin positioned in the housing and to which the first end of the first cable is attached, wherein the first cable can be wound and unwound from the first bobbin;
a first cable anchoring fixedly attached within the bottom slat and with which the second end of the first cable is anchored;
a second cable extending between a first end and a second end;
a second bobbin positioned in the housing opposite the first bobbin and to which the first end of the second cable is attached, wherein the second cable can be wound and unwound from the second bobbin; and
a second cable anchoring fixedly attached within the bottom slat and with which the second end of the second cable is anchored,
wherein each cable anchoring comprises:
a frame placed in the bottom slat, the frame having an entry opening configured for receiving a cable end of a respective one of the cables;
a bobbin rotatably attached on the frame of the cable anchoring and configured for winding the cable end thereon;
a worm gear fixedly attached to the bobbin; and
a worm attached on the frame and engaging the worm gear, wherein the worm and the worm gear together form a self-locking worm gear reducer.

2. The motorized non-vertical sun protection screen according to claim 1, wherein the worm has a screw thread with an angle of inclination of at most 3°, preferably at most 2°, and more preferably at most 1°.

3. The motorized non-vertical sun protection screen according to claim 1, wherein the worm gear has a pitch circle diameter which is at most 25 mm, in particular at most 20 mm, more in particular at most 17 mm, and most in particular at most 13 mm.

4. The motorized non-vertical sun protection screen according to claim 3, wherein the worm gear has an outer diameter which is at most 35 mm, in particular at most 30 mm, more in particular at most 25 mm, and most in particular at most 22 mm.

5. The motorized non-vertical sun protection screen according to claim 4, wherein the worm has a screw thread with an outer diameter which is at most 25 mm, in particular at most 20 mm, more in particular at most 17 mm, and most in particular at most 14 mm.

6. The motorized non-vertical sun protection screen according to claim 5, wherein the tensioning system further comprises:
a first guide for guiding the first cable from the housing to the bottom slat through the first side guide via the first end of the bottom slat; and
a second guide for guiding the second cable from the housing to the bottom slat through the second side guide via the second end of the bottom slat.

7. The motorized non-vertical sun protection screen according to claim 6, wherein the first guide comprises:
a first pulley within the first side guide near an end thereof, which end is located opposite to the housing;
a second pulley within the bottom slat near the first end thereof; and
a third pulley within the bottom slat, and
wherein the second guide comprises:
a first pulley within the second side guide near an end thereof, which end is located opposite to the housing;
a second pulley within the bottom slat near the second end thereof; and
a third pulley within the bottom slat.

8. The motorized non-vertical sun protection screen according to claim 7, wherein the tensioning system further comprises one or more tensioning elements which pull the third pulley of the first guide away from the first end of the bottom slat and which pull the third pulley of the second guide away from the second end of the bottom slat.

9. The motorized non-vertical sun protection screen according to claim 8, wherein the one or more tensioning elements are formed by a spring element, in particular a tension spring, which interconnects the third pulley of the first guide and the third pulley of the second guide.

10. The motorized non-vertical sun protection screen according to claim 9, wherein the first cable anchoring is located between the second pulley and the third pulley of the first guide, and wherein the second cable anchoring is located between the second pulley and the third pulley of the second guide.

11. The motorized non-vertical sun protection screen according to claim 10, wherein each cable comprises a core that is surrounded by a woven sheath.

12. The motorized non-vertical sun protection screen according to claim 11, wherein the core is formed by a plurality of parallel strands which are preferably pre-stretched.

13. The motorized non-vertical sun protection screen according to claim 12, wherein the strands are manufactured from a synthetic fibre, in particular a synthetic fibre based on polyethylene, more in particular ultra-high molecular weight polyethylene.

14. A method of mounting a cable anchoring in a motorized non-vertical sun protection screen, the method comprising:
providing a cable anchoring comprising:
a frame configured for being placed in a bottom slat of the motorized non-vertical sun protection screen, the frame having an entry opening configured for receiving a cable end of a cable;
a bobbin rotatably attached on the frame of the cable anchoring and configured for winding the cable end thereon;
a worm gear fixedly attached to the bobbin; and
a worm attached on the frame and engaged the worm gear, wherein the worm and the worm gear together form a self-locking worm gear reducer;
securing the frame of the cable anchoring in the bottom slat of the motorized non-vertical sun protection screen;
inserting a cable end of a cable through the entry opening and attaching it to the bobbin; and
turning the worm for tensioning the cable.

15. A method for replacing an existing cable anchoring in a motorized non-vertical sun protection screen, the method comprising:
relaxing a cable in the motorized non-vertical sun protection screen;
detaching a cable end of the cable from the existing cable anchoring;
removing the existing cable anchoring from a bottom slat of the motorized non-vertical sun protection screen; and
carrying out the method according to claim 14.
